(19) United States
(12) Patent Application Publication
(10) Pub. No.: US 2005/0044051 A1
(43) Pub. Date: Feb. 24, 2005

(54) Combo kit and method of providing a combo kit

(76) Inventors: David A. Selby, Oconomowoc, WI (US); Michael W. Kirby, Menomonee Falls, WI (US); Shaun Horan, Muskego, WI (US)

Correspondence Address: MICHAEL BEST & FRIEDRICH, LLP, 100 E WISCONSIN AVENUE, MILWAUKEE, WI, 53202, US

(21) Appl. No.: 10/646,610

(22) Filed: Aug. 22, 2003

(51) Int. Cl. G06F 17/60; G06F 17/00

(52) U.S. Cl. 705/500

(57) ABSTRACT

Combo kits and methods for providing a combo kit. In some aspects, the method of providing the power tool combo kit provides the economic benefit of purchasing power tools in a combo kit while providing the flexibility of purchasing power tools individually. The method may include the acts of the provider providing an available group including multiple power tools of various tool models. The customer may review the available group and provide a desired group or customer selection indicating the requested power tools to be included in the combo kit. The method may further include the provider receiving the desired request from the customer including multiple power tools from the available group. The provider selects a selected group including multiple power tools from the available group. The selected group matches the desired request. The provider provides the combo kit including the selected group having multiple power tools.

### FIELD OF THE INVENTION

This invention relates to power tools, and more particularly to a method for providing a power tool combo kit.

### SUMMARY OF THE INVENTION

Power tools have previously been provided and sold as individual tools. Some power tools have been combined together to be provided and sold as a combo kit. Existing power tool combo kits are limited in the number of power tools that are available and include limited combinations of power tools. Combo kits are particularly popular with cordless power tools, which are interchangeably usable with a single rechargeable battery. Combo kits for cordless power tools help customers avoid purchasing redundant battery chargers and excess rechargeable batteries that may be used with the multiple power tools of the combo kit.

The contents of prior art power tool combo kits are determined by the manufacturer and are pre-packaged without direct input from a customer. Under this arrangement, several different combo kits must be developed and stocked, which may be costly and burdensome for the manufacturer and distributor. In addition, the customer may be unable to purchase a combo kit having the desired mix of power tools. While there are many possible combinations of power tools that may be included in a combo kit, existing combo kits provide a very limited number of power tool combinations. Also, existing power tool combo kits only provide a single power tool of each tool model.

The present invention generally provides a combo kit and a method for providing a combo kit which substantially alleviates one or more independent problems with existing combo kits and methods. In some aspects, the method generally permits the combo kit to be provided custom-tailored to the desires of the customer. In some aspects, the method of providing the power tool combo kit generally provides the economic benefit of purchasing power tools in a combo kit while providing the flexibility of purchasing power tools individually. In some aspects, the power tool combo kit generally includes a first customer-selected power tool and a second customer-selected power tool. In some aspects, the first customer selected power tool and the second customer-selected power tool are of the same tool model, and, in some aspects, the power tool combo kit includes a battery and battery charger.

More particularly, in some aspects, the method generally includes the acts of a provider providing an available group including multiple power tools of various tool models. A customer may review the available group and provide a desired group or customer selection indicating the power tools the customer wishes to have included in the combo kit. The method may further include the act of the provider receiving the desired request from the customer including multiple requested power tools from the available group. The provider selects a selected group including multiple selected power tools from the available group. The selected group corresponds to or matches the desired request. The provider provides the combo kit comprising the selected group having multiple selected power tools.

In some aspects, the method may include the act of providing a carrying case having sufficient space to store the selected tools. The carrying case may include a rigid case made of hard plastic or metal or may include a bag or flexible container.

In some aspects, at least two of the power tools in the selected group are cordless power tools. The method may include the act of providing a battery charger and at least one rechargeable battery compatible with the battery charger. At least one of the cordless power tools in the selected group are compatible with the battery. The combo kit may include a carrying case having sufficient space to store the selected tools, the battery charger, and the rechargeable battery.

In some aspects, a first battery is compatible with a first power tool from the available group but not with a second power tool from the available group, and a second battery is compatible with the second power tool but not with the first power tool. In some aspects, the battery charger is operable to charge both the first battery and the second battery.

In some aspects, the selected group may include at least two power tools of the same tool model. In some aspects, the available group include both cordless power tools and corded power tools. In some aspects, the combo kit is a single purchase unit.

Independent features and independent advantages of the invention will become apparent to those skilled in the art upon review of the following detailed description, claims and drawings.

### BRIEF DESCRIPTION OF THE DRAWINGS

FIG. 1A illustrates at least a portion of an available group of multiple power tools for a combo kit.

FIG. 1B illustrates at least a portion of an available group of multiple power tools for a combo kit.

FIG. 2 is a perspective view of a battery charger.

FIG. 3A is a perspective view of a battery charger.

FIG. 3B is a perspective view of a battery charger.

FIG. 4 is a perspective view of two constructions of a carrying case.

FIG. 5 illustrates at least a portion of an available group of multiple power tools for a combo kit.

FIG. 6 illustrates at least a portion of an available group of multiple power tools for a combo kit.

FIG. 7 is a diagram illustrating a grouping of power tools for a combo kit.

FIG. 8 is a diagram illustrating a grouping of power tools for a combo kit.

Before any embodiments of the invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting.

Although references are made below to directions, such as left, right, up, down, top, bottom, front, rear, back etc., in describing the drawings, they are made relative to the drawings (as normally viewed) for convenience. These directions are not intended to be taken literally or limit the present invention in any form.

### DETAILED DESCRIPTION

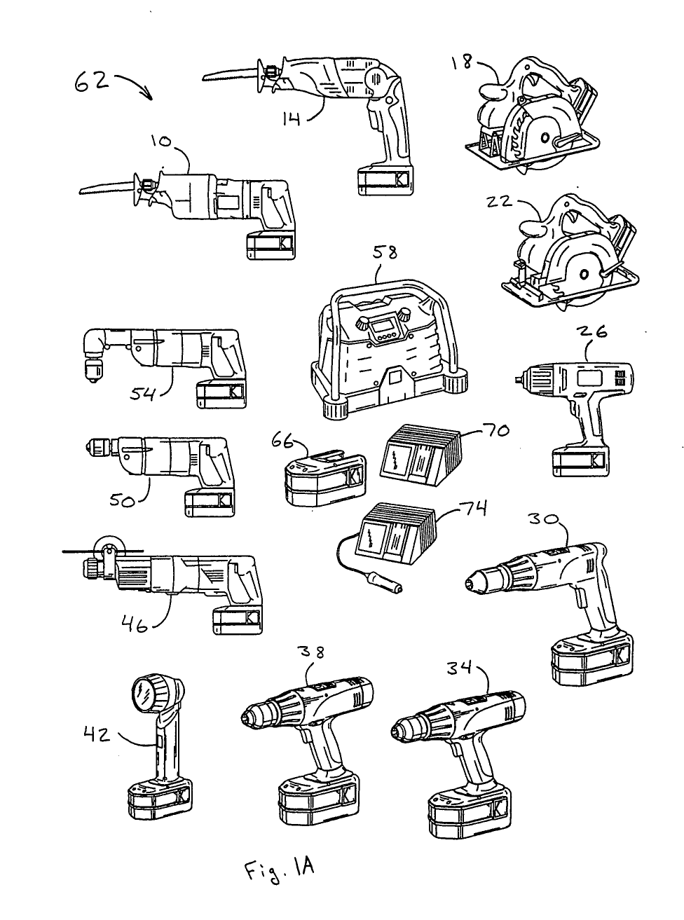

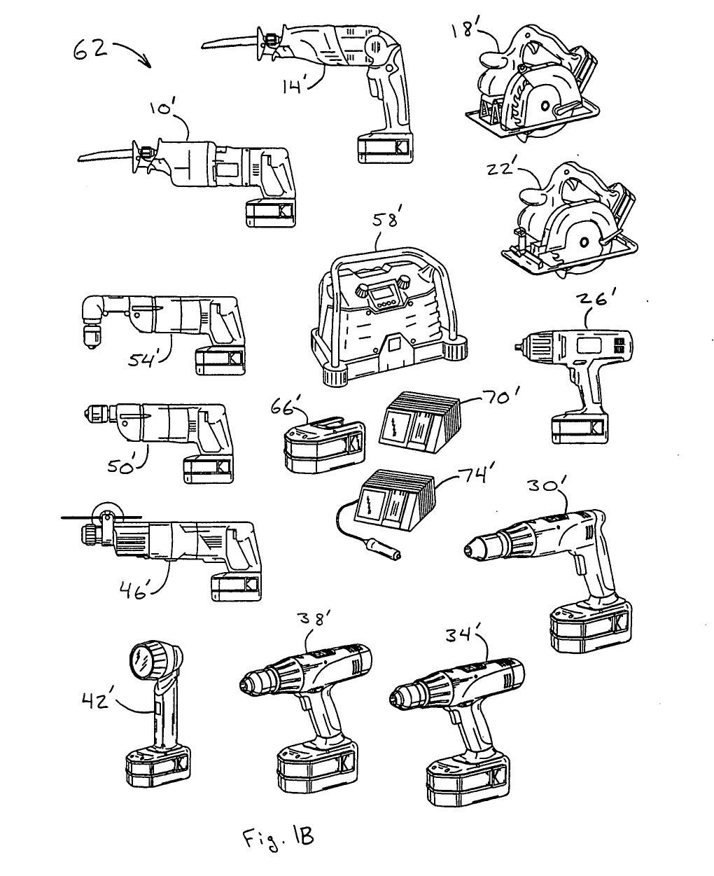

FIG. 1A illustrates multiple cordless power tools of various tool models. FIG. 1A illustrates a reciprocating saw 10, an angled reciprocating saw 14, a metal cutting circular saw 18, a circular saw 22, an impact wrench 26, an extended hammer-drill driver 30, a hammer-drill driver 34, a driver/drill 38, a work light 42, a rotary hammer 46, a D-handle drill 50, a right angle drill 54, and a portable radio 58. At least some of the power tools illustrated in FIG. 1A form at least a portion of an exemplary available group 62 of power tools. The available group may include other cordless power tools not illustrated in FIG. 1A. In FIG. 1A, all of the illustrated power tools in the available group 62 are cordless power tools, however, as described below, the available group 62 may also include corded tools.

FIG. 1A illustrates a rechargeable battery 66, a battery charger 70, and a car adaptable battery charger 74. The battery 66 is interchangeable and connectable with at least one of and, in the illustrated construction, each of the cordless power tools of the available group 62 to provide power for the respective power tool. The battery 66 is also connectable with the battery chargers 70, 74 to be recharged. The battery chargers 70, 74 shown in FIG. 1A have a generally horizontal body.

FIG. 1B illustrates a second rechargeable battery 66′ that may be compatible with at least one of the cordless power tools of at least a portion of the available group 62. The batteries 66 and 66′ may be operable and compatible with different tools from the available group 62. The batteries 66 and 66′ may have a similar appearance, as shown in FIGS. 1A and 1B, however, the batteries 66 and 66′ may have some differences. For example, the battery 66 may be a battery of a first voltage (for example, 18V) which is compatible with the driver/drill 38 which operates at about the first voltage (for example, about 18V), and the battery 66′ may be a battery of a second voltage (for example, 28V) which is compatible with the circular saw 22′ which operates at about the second voltage (for example, about 28V). Using this example, the 18V battery 66 may not be compatible with 28V circular saw 22′, and the 28V battery 66′ may not be compatible with the 18V driver/drill 38. Both the 18V battery 66 and the 28V battery 66′ may be compatible with the battery charger 70 or 70′. The combo kit may include one or more batteries 66, 66′ of varying voltages, such as, for example, 18V, 28V, etc. In other constructions, the batteries 66 and 66′ may have different appearances. Also, in other constructions, some of the power tools may be compatible with both batteries 66 and 66′.

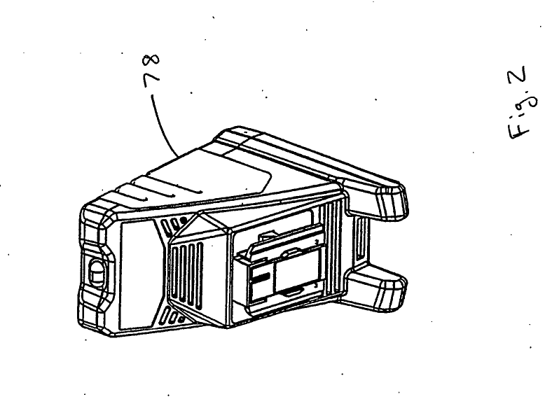

FIG. 2 illustrates an alternative battery charger 78 having a generally vertical body. The vertical battery charger 78 is also connectable with the batteries 66 and 66′ (FIGS. 1A and 1B) to recharge the battery 66. The vertical battery charger 78 includes the same type of mounting portion that engages the battery 66, 66′ as the horizontal battery charger 70 (FIG. 1A or 1B). However, in the vertical battery charger 78, the internal components are configured in the relatively vertical body arrangement instead of the generally horizontal body arrangement.

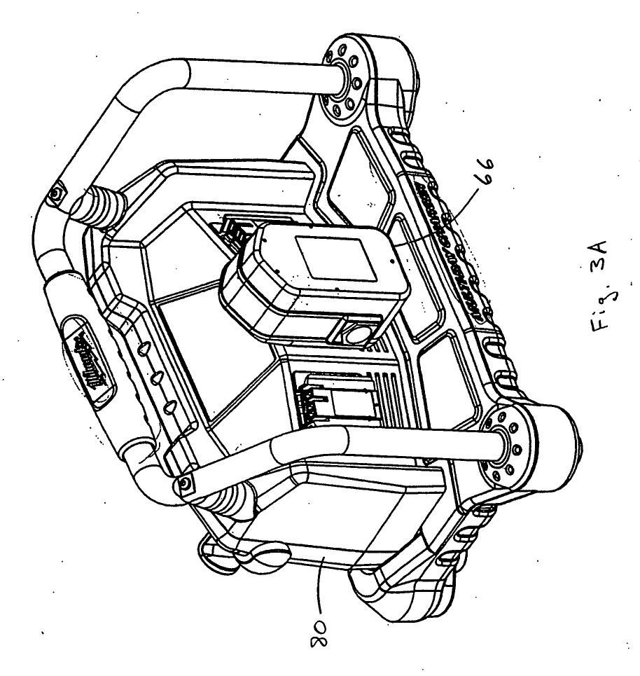

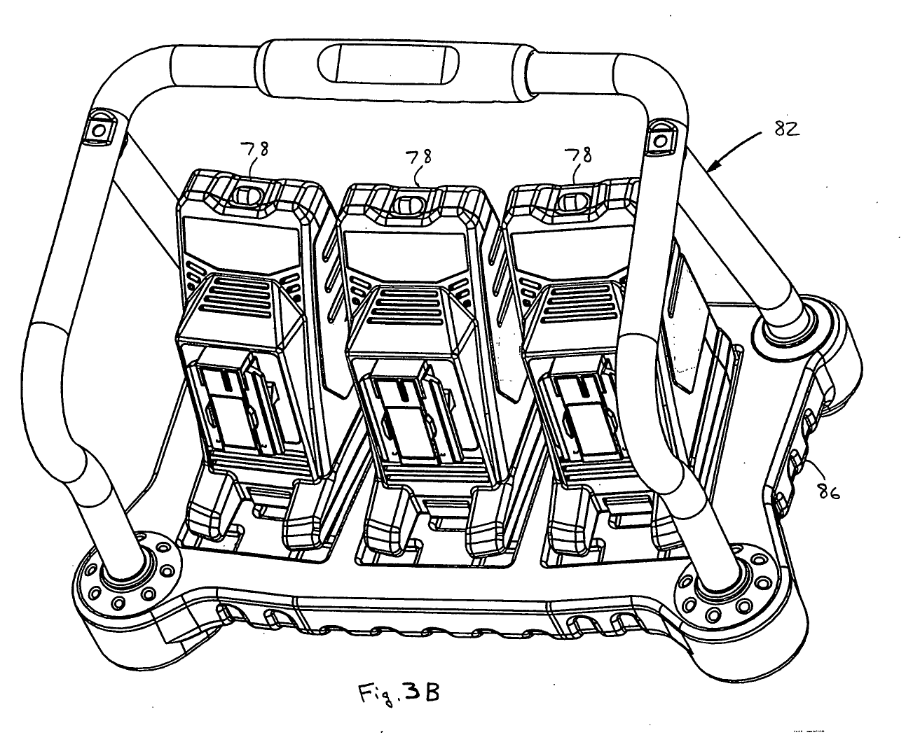

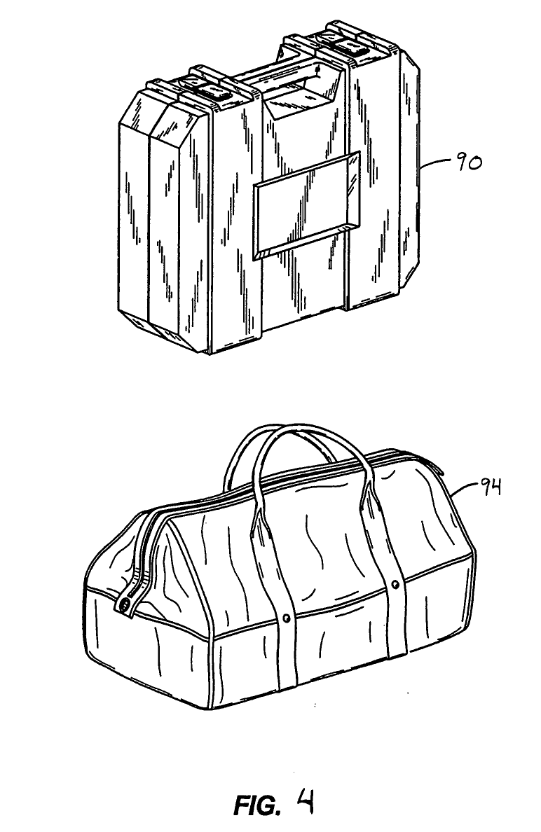

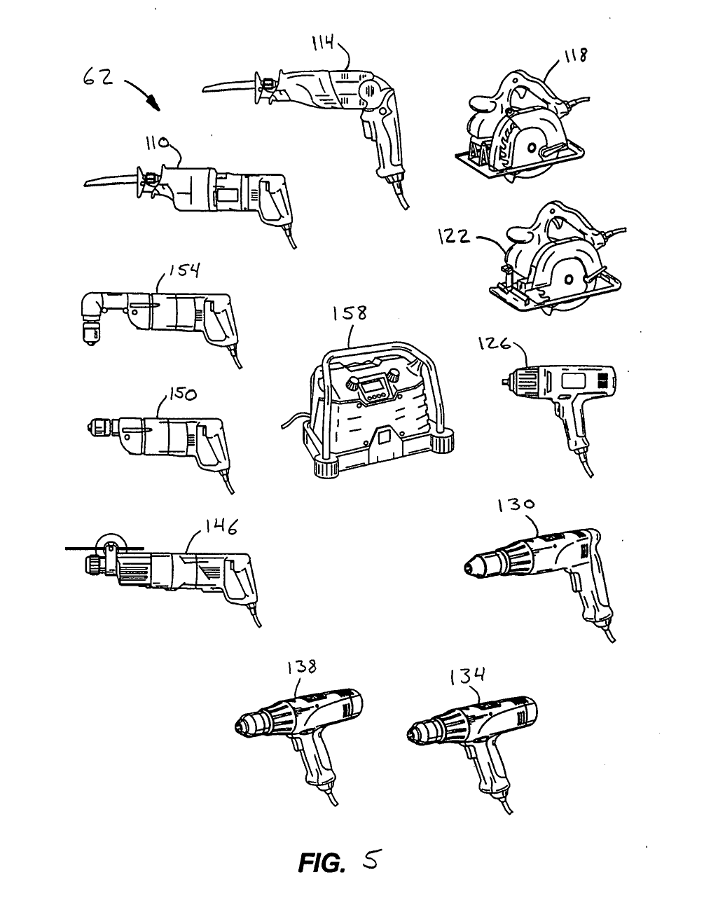

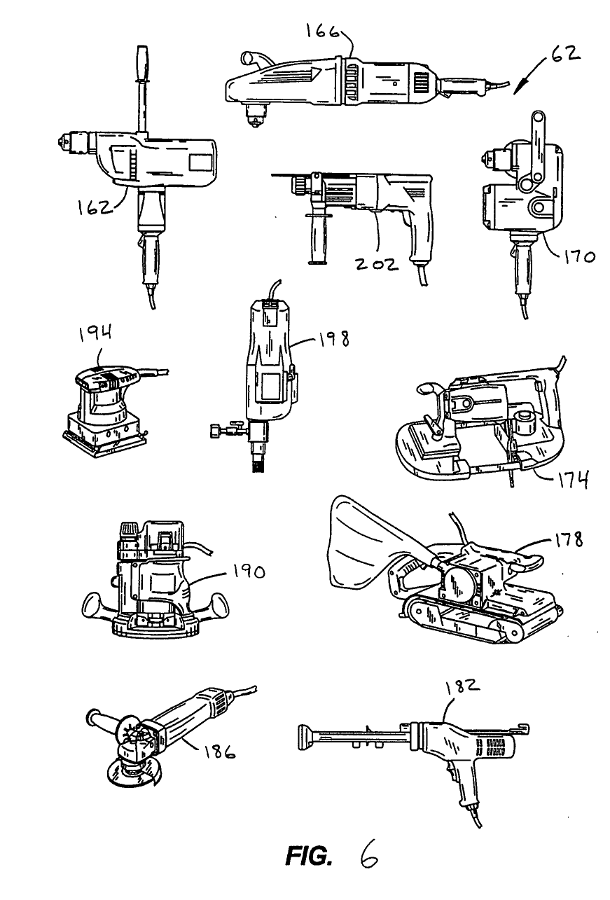

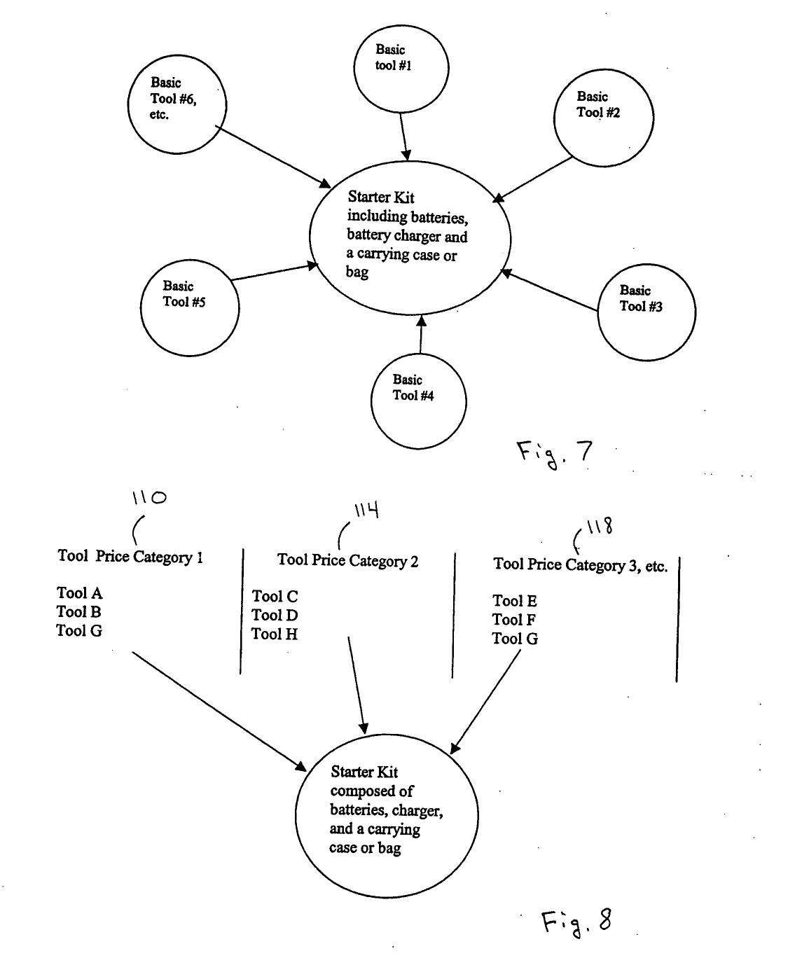

FIG. 3A illustrates a multi-bay battery charger 80 capable of simultaneously charging multiple batteries 66. The multi-bay charger 80 includes multiple mounting portions to simultaneously engage multiple batteries 66, 66′. An example of the battery charger 80, as shown in FIG. 3A, is illustrated and described in U.S. Patent Application entitled “BATTERY CHARGER”, filed on Nov. 7, 2002 and having Ser. No. 10/289,621, the entire contents of which are incorporated herein by reference.

FIG. 3B illustrates a multi-bay battery charger 82 capable of simultaneously recharging multiple rechargeable batteries 66 or 66′ (FIG. 1A or 1B). The multi-bay battery charger 82 includes a carrying caddy 86 and multiple vertical battery chargers 78 connected to the caddy 86. The vertical configuration of the battery chargers 78 permit the chargers 78 to be connected in relatively close proximity to one another on the caddy 86 and minimize the over all width of the multi-bay charger 82. The multi-bay charger 82 may include a single cord to provide power to the multi-bay charger 82. Alternatively, each vertical battery charger 78 may be removed from the caddy 86 and may include its own cord to individually recharge a battery 66. An example of the battery charger 82, as shown in FIG. 3B, is illustrated and described in U.S. Provisional Patent Application entitled “BATTERY CHARGER AND ASSEMBLY”, filed on May 7, 2003 and having Ser. No. 60/468,566, the entire contents of which are incorporated herein by reference.

The horizontal battery charger 70, the vertical battery charger 78, and the multi-bay battery charger 82 all may include a power cord connectable to a standard AC current outlet to provide power to recharge the battery 66. The car adaptable battery charger 74 may include a power cord connectable to a DC current power source, such as a car cigarette lighter, to provide power to recharge the battery 66. Any of the chargers 70, 74, 78, 82 may be used to recharge the battery 66, 66′. In some aspects, one battery charger may charge battery 66 but not battery 66′, and another battery charger may charge battery 66′ but not battery 66. In some aspects, one battery charger may charge both batteries 66, 66′.

FIG. 4 illustrates a carrying case 90 having sufficient space to store the tools of the combo kit. The carrying case 90 may include a hard rigid case, as shown in FIG. 4. Alternatively, the carrying case may include a bag 94, a bin, a mounted storage holder, a rack, or other similar storing or transporting apparatus. The carrying case 90 may be designed to store the specific power tools of the desired combo kit. Additionally, the carrying case 90 may only carry the rechargeable battery 66 and battery charger 74, and the power tools may be stored or transported separately. The carrying case 90 may also only carry a portion of the power tools of the combo kit.

In some aspects, the available group 62, as shown in FIG. 1A or 1B, may include the rechargeable battery 66 or 66′, the horizontal battery charger 70, the car adaptable battery charger 74, the vertical battery charger 78 (FIG. 2), and the multi-bay battery charger 82 (FIG. 3). The available group 62 may also include the carrying case 78 (FIG. 4). In some aspects, the combo kit may include a starter kit including the battery 66 or 66′, at least one of the battery chargers 70, 74, 78, 82 and the carrying case 78. The starter kit may form the foundation of the combo kit, and various power tools of the combo kit may be selected from the available group 62 to be added to the starter kit and complete the combo kit.

As discussed above and shown in FIGS. 1A and 1B, the available group 62 may include cordless power tools, however, the available group 62 may also include corded power tools. FIGS. 5-6 illustrate various corded power tools that may be included in the available group 62. FIG. 5 illustrates an exemplary available group 62 including a reciprocating saw 110, an angled reciprocating saw 114, a metal cutting circular saw 118, a circular saw 122, an impact wrench 126, an extended hammer-drill driver 130, a hammer-drill driver 134, a driver/drill 138, a rotary hammer 146, a D-handle drill 150, a right angle drill 154, and a portable radio 158. FIG. 6 illustrates the available group 62 including a super hole-shooter drill 162, an extended hole boring drill 166, a hole boring drill 170, a portable band saw 174, a belt sander 178, a caulk gun 182, a sander/grinder 186, a grinder 190, an orbital sander 194, a coring drill 198, and a rotary hammer 202. It should be understood that the available group 62 may include other similar corded power tools not illustrated in the Figures. In some aspects, the available group 62 may include other types of tools, such as pneumatic tools and accessories, and may include other equipment such as generators, lawn and garden equipment, and electronic equipment.

The available group 62 may include cordless power tools, as shown in FIGS. 1A and 1B, and may also include corded power tools, as shown in FIGS. 5-6. The combo kit may also include a combination of both cordless power tools and corded power tools. FIGS. 1A-1B and 5-6 only illustrate a single power tool of each tool model. The available group 62 includes a substantially inexhaustible supply of power tools, and may include multiple power tools of the same tool model. The combo kit may include virtually limitless combinations of the various power tools of the available group, including multiple power tools of the same tool model. For example, the combo kit may include five drills 38, three reciprocating saws 10, etc. Almost any conceivable combination of power tools from an available group 62 may be combined into the combo kit.

For the purposes of this invention, various classifications of power tools will be defined. The term “power tools” generally represents all power tools, including but not limited to, bandfiles, caulk and adhesive guns, circular saws, D-handle drills, driver/drills, hammer-driver drills, impact wrenches, jig saws, radios, rotary hammers, reciprocating saws, screwdrivers, work lights, cut-off machines, coring drills, drain cleaners, hoists, trolleys, slings, polishers, routers, sanders, grinders, band saws, hack saws, chain saws, miter saws, shears, vacuums, power tool accessories, and other similar portable or non-portable power equipment. The term “power tools” may also include both corded and cordless power tools.

“Power tools” may be sub-classified into multiple “types of power tool.” A “type of power tool” is a specific power tool, such as a drill, or other power tools from the preceding list. Multiple manufacturers generally make power tools of the same “type of power tool,” and a single manufacturer may make multiple versions of a “type of power tool.” A “type of power tool” may be sub-classified into multiple “tool models.” A “tool model” is a specific type of power tool and represents individual power tools that are substantially identical to other individual power tools of the same “tool model.” A “tool model” is generally unique to a manufacturer, and multiple “tool models” may be classified under the same “type of power tool.” A “tool model” is generally referred to by a model number or catalog number. For example, a drill may be a “type of power tool”, but there may be multiple “tools models” of drills.

In the described example, the method acts may be listed in an order, however, it is not necessary to perform the acts in the illustrated order to perform the method of the invention. Also, it is not necessary to perform all of the described acts to practice the invention. It should be understood that the method of the invention is defined in the claims and the figures and detailed description merely provide a examples of some aspects of the method.

The method includes multiple acts performed by the provider to provide the combo kit to the customer. The method may include interaction from the customer to select which tools are in the combo kit, and the customer may perform some acts of the method. The provider includes any supplier of the power tool combo kit and may include a manufacturer, a distributor, a retailer, or other parties in the transaction of the combo kit. The customer includes any recipient of the power tool combo kit, and may include a distributor, a retailer, an intermediary, an end purchaser, or any other parties in the transaction of the combo kit.

The provider provides an available group 62 of power tools. The available group includes multiple power tools of various tool models. The available group may also include multiple power tools of the same tool model and may include a relatively unlimited supply of power tools of the same model. FIGS. 1A-1B and 5-6 illustrate examples of power tool models that may be included in the available group.

In some aspects, the customer selects which power tools from the available group 62 are desired in the combo kit, and the customer generates a desired request or customer selection of the desired or requested power tools from the available group. The desired request may include a wide variety of combinations of various power tools from the available group 62 and, in some aspects, may include multiple power tools of the same tool model. The desired request permits the customer to customize the combo kit for his/her individual needs. For example, a customer that repeatedly performs a single task may require multiple power tools of the same tool model instead of a variety of power tools representing different tool models. For example, a customer that is a drywall contractor may have a large demand for drywall screwdrivers and a lower demand for other tools. In this case, the customer can request a combo kit with multiple drywall screwdrivers.

The desired request may also include additional batteries 66 or 66′, battery chargers, or other power tool accessories. Additional batteries 66 or 66′ may be helpful for a customer that must continually use the power tool while the battery 66 or 66′ requires recharging. The customer may customize the combo kit after determining his/her specific need for additional batteries, battery chargers, and other accessories.

The provider receives the desired request from the customer and selects a selected group of selected power tools in response to the desired request. The selected group includes multiple power tools from the available group and corresponds to or matches the desired request. If a requested tool is unavailable, the provider may suggest, for customer approval, or provide another similar power tool of the same type. In some aspects, the customer selection and the selected group may include multiple power tools of the same tool model. The selected group will eventually be part of the combo kit.

The provider provides the combo kit including the selected group of power tools. Power tool accessories, such as batteries and battery chargers, may be included within the selected group or may be provided separately as part of the combo kit. The provider may also provide the starter kit that may include batteries 66, 66′, battery chargers 70, 74, 78, 82, and/or the carrying case 90 or bag 94. The starter kit may be combined with the selected group to form the complete combo kit.

In some aspects, the combo kit may include cordless power tools. When the combo kit includes cordless tools, the combo kit may also include the battery charger 70, 74, 78, 82 and battery 66 and/or 66′ that is interchangeable with at least one of the cordless power tools of the combo kit and may be used to power at least one of the power tools of the combo kit. The battery 66 or 66′ is connectable to the battery charger 70 to recharge the power supply of the battery 66 or 66′. The battery charger 70 may include the single bay charger 70, 74, 78, as shown in FIGS. 1-2, the multi-bay charger 80, as shown in FIG. 3A, and/or the multi-bay charger 82, as shown in FIG. 3B. The provider provides the battery charger 70, 74, 78, 82 and rechargeable battery 66 and/or 66′.

In some aspects, the combo kit may include the carrying case 90 having sufficient space to store the selected tools of the combo kit. The provider may provide the carrying case 90 to the customer as part of the combo kit or as an individual unit separate from the combo kit.

In some aspects, the combo kit may also include power tool accessories, such as a belt clip, a light, a bit holder, a blade holder, a level, blades, bits, or other similar accessories for use with power tools. The power tool accessories may be included as part of the available group and may be selected by the customer.

The combo kit is a single purchase unit, meaning that the combo kit is registered as a single entity during purchase. The combo kit is not registered as multiple tools sold as multiple units grouped together in a single sale. For example, in a sale involving a printed receipt, the combo kit will be listed as a single purchase item on the receipt, though it may identify selected components of the combo kit. The single purchase unit may be used for tracking sales and inventory of the power tools.

Since the combo kit may include various combinations of power tools, the pricing for the combo kit may depend on many factors, including the type and quantity of power tools in the combo kit. FIG. 7 illustrates a version of the method for providing a cordless power tool combo kit in which the provider provides a starter kit for the customer. The starter kit includes at least one rechargeable battery, a battery charger, and may also include the carrying case 90 or bag 94. The customer selects which power tools are included in the combo kit, and the provider then provides the complete combo kit including the starter kit and the power tools chosen by the customer. The price of the combo kit will depend on which power tools are included in the combo kit, and each tool model may attribute a certain portion of the price for the combo kit. For example, a drill of a specific tool model may attribute a first amount to the overall price of the combo kit and a reciprocating saw of a specific tool model may attribute a second amount to the overall price of the combo kit. Of course, the exact amount attributed to each tool model may differ from this example and may be determined by the provider.

FIG. 8 illustrates another version of the method for providing a cordless combo kit in which the available group may also be divided into multiple sub-groups, such as a first sub-group 110, a second sub-group 114 and a third sub-group 118, to determine pricing for the combo kit. Each sub-group may include power tools of multiple tool models and may define a tool price category. The price of the combo kit may be determined in response to the number of power tools selected from each sub-group 110, 114, 118. For example, a combo kit comprising a certain number of power tools from each sub-group may have a first price, while a combo kit comprising a different number of power tools from each sub-group may have a second price.

In some aspects, the portion of the price of the combo kit attributed to each power tool may be the same for each power tool from the same sub-group. For example, each power tool in the first sub-group 110 may attribute a first amount to the price of the combo kit, each power tool in the second sub-group 114 may attribute a second amount to the price of the combo kit, and each power tool in the third sub-group 118 may attribute a third amount to the price of the combo kit.

The sub-groups 110, 114, 118 may be classified by types of power tools. For example, the first sub-group 100 may comprise drills, the second sub-group 114 may include reciprocating saws, the third sub-group 118 may include circular saws. Using this example, a combo kit having two drills, three reciprocating saws, and two circular saws may have a first price, and a combo kit having a different combination of power tools may have a second price.

Alternatively, the sub-groups 110, 114, 118 may be grouped based on the level of features of the power tool. For example, the first sub-group 110 may include entry level power tools of multiple tool models, the second sub-group 114 may include power tools of multiple tool models having additional features in comparison the first sub-group 110, and the third sub-group 118 may include power tools of multiple tool models having additional features in comparison to the second sub-group 114.

In some aspects, each sub-group 110, 114, 118 may include power tools of an individual tool model. For example, every power tool of the first sub-group 110 would be substantially the same tool model. This classification may include a relatively large number of sub-groups and may provide additional flexibility in pricing for the combo kit.

In some aspects, the portion of the price of the combo kit attributed to each power tool may decrease for each additional power tool added to the combo kit. For example, the first power tool selected may attribute a first amount to the price of the combo kit, the second power tool selected may attribute a second amount to the price of the combo kit, and the third power tool selected may attribute a third amount to the price of the combo kit, in which the second amount is less than the first amount, and the third amount is less than the second amount. The pricing may also be stepped to provide a price break after a fixed number of power tools. For example, the first two power tools may attribute a first amount to the price of the combo kit, and the next two power tools may attribute a reduced amount to the price of the combo kit. Pricing may also include a minimum number of power tool selected for the combo kit.

The combo kit may include other corded and/or cordless equipment other than power tools. For example, the available group may include lawn and garden equipment, electronic equipment, audio and video equipment, cell phones, PDAs, e-organizers, computers, or other similar equipment. For cordless equipment, the equipment may share the same power source including batteries and battery chargers.

One or more independent features and independent advantages of the invention are set forth in the following claims.

1. A method for providing a power tool combo kit from a provider to a customer, the method comprising the acts of:
providing an available group including multiple power tools of various tool models;
receiving a desired request from the customer of multiple requested power tools from the available group;
selecting a selected group of multiple selected power tools from the available group, the selected group corresponding to the desired request; and
providing the combo kit including the selected group of multiple selected power tools.

2. The method of claim 1, wherein the act of providing the combo kit further comprises the act of providing a carrying case having sufficient space to store the selected power tools.

3. The method of claim 1, wherein at least two of the selected power tools in the selected group are cordless power tools, and wherein the act of providing the combo kit further comprises the act of providing a battery charger and at least one rechargeable battery compatible with the battery charger, at least one of the selected cordless power tools being compatible with the battery.

4. The method of claim 3, wherein the first-mentioned battery is incompatible with another of the selected cordless power tools, and a second battery is compatible with the other of the selected cordless power tools and incompatible with the at least one of the selected cordless power tools, the battery charger being operable to charge the first battery and the second battery.

5. The method of claim 1, wherein the selected group includes at least two power tools of the same tool type.

6. The method of claim 5, wherein the selected group includes at least two power tools of the same tool model.

7. The method of claim 1, wherein the available group include both cordless power tools and corded power tools.

8. The method of claim 1, wherein the combo kit is a single purchase unit.

9. A method for providing a power tool combo kit, the method comprising the acts of:
providing an available group including multiple power tools of various tool models;
selecting a selected group including multiple selected power tools from the available group, the selected group including multiple power tools of the same tool type; and
providing a combo kit to the customer, the combo kit including the selected group.

10. The method of claim 9, wherein the selected group includes at least two power tools of the same tool model.

11. The method of claim 9, wherein at least two of the power tools in the selected group are cordless power tools, and wherein the act of providing the combo kit further comprises the act of providing a battery charger and at least one rechargeable battery compatible with the battery charger, at least one of the selected cordless power tools being compatible with the battery.

12. The method of claim 11, the act of providing the combo kit further comprising the act of providing a carrying case having sufficient space to store the selected tools, the battery charger, and the battery.

13. The method of claim 9, wherein the combo kit is a single purchase unit.

14. The method of claim 9, wherein the method further comprises the act of receiving a desired request from a customer of multiple requested power tools from the available group, and wherein the selected group corresponds to the desired request.

15. A method for providing a power tool combo kit from a provider to a customer, the method comprising the acts of:
providing an available group including multiple cordless power tools of various tool models;
receiving a customer request of multiple requested power tools from the available group;
providing a selected group of multiple selected power tools in response to the customer request, the selected group corresponding to the customer request; and
providing a combo kit including the selected group, a battery charger, and a battery compatible with the battery charger, the battery being compatible with at least one of the cordless power tools to power the at least one of the cordless power tools of the combo kit.

16. The method of claim 15, wherein the selected group includes at least two power tools of the same tool type.

17. The method of claim 16, wherein the selected group includes at least two power tools of the same tool model.

18. The method of claim 15, wherein the combo kit is a single purchase unit.

19. The method of claim 15, wherein the combo kit includes the first-mentioned battery and a second battery, the first-mentioned battery being compatible with a first cordless power tool of the selected group and being incompatible with a second cordless power tools of the selected group, the second battery being compatible with the second cordless power tool and being incompatible with the first cordless power tool, the battery charger being operable to charge the first battery and the second battery.

20. The method of claim 19, wherein a third cordless power tool of the selected group is compatible with both the first battery and the second battery.

21. The method of claim 15, wherein the available group includes corded power tools and cordless power tools.

22. The method of claim 21, wherein the customer request includes corded power tools and cordless power tools.

23. A method for providing a power tool combo, the method comprising the acts of:
providing an available group including multiple cordless power tools of various tool models;
selecting a selected group of multiple selected power tools from the available group, the selected group including at least two power tools of the same tool type; and
providing a combo kit including the selected group, a battery charger, and at least one rechargeable battery compatible with the battery charger, the battery being compatible with at least one of the cordless power tools in the available group.

24. The method of claim 23, wherein the selected group includes at least two power tools of the same tool model.

25. The method of claim 23, wherein the combo kit is a single purchase unit.

26. The method of claim 23, further comprising the act of receiving a customer request of multiple requested power tools from the available group, the selected group corresponding to the customer request.

27. A method for providing a power tool combo kit from a provider to a customer, the method comprising:
providing an available group of multiple power tools;
selecting a selected group including multiple selected power tools from the available group;
providing a combo kit including the selected group, the combo kit being a single purchase unit; and
determining a price of the single purchase unit in response to the multiple selected power tools in the selected group.

28. The method of claim 27, wherein the act of providing a combo kit includes providing a battery charger and at least one rechargeable battery compatible with the battery charger, at least one of the selected power tools being compatible with the battery.

29. The method of claim 27, wherein the selected group includes at least two power tools of the same tool type.

30. The method of claim 29, wherein the selected group includes at least two power tools of the same tool model.

31. The method of claim 27, wherein the available group includes multiple sub-groups, each sub-group including multiple power tools, the act of determining the price of the single purchase unit being in response to the sub-group from which each of the selected tools are selected.

32. The method of claim 27, wherein each of the sub-groups include power tools of various tool models.

33. A combo kit comprising:
a first power tool of a first tool type; and
a second power tool of the first tool type.

34. The combo kit of claim 33, wherein the first power and the second power tool are the same tool model.
